(19) United States
(12) Patent Application Publication
(10) Pub. No.: US 2005/0205331 A1
(43) Pub. Date: Sep. 22, 2005

(54) Automatic Driver's Aide

(75) Inventor: Polchai Phanumphai, Bangkok (TH)

Correspondence Address: RACHASAK PHANUMPHAI, 9417 E. ARIZONA PLACE, DENVER, CO, 80247, US

(73) Assignees: Mr. Polchai Phanumphai, Bangkok (TH); Mr. Rachasak Phanumphai, Denver, CO (US); Mr. Steven A. Silvers, West Palm Beach, FL (US)

(21) Appl. No.: 10/708,635

(22) Filed: Mar. 17, 2004

(51) Int. Cl. B60R 21/00

(52) U.S. Cl. 180/271; 180/272; 180/282

(57) ABSTRACT

process again and allow gathering of new data. This equipment hence has many benefits in reducing accidents when the driver loses consciousness or loses the sufficient attention to operate the vehicle. Lacking consciousness while driving can cause both the people, passenger's life, and savings

### BACKGROUND OF INVENTION

Presently, there is no safety equipment on the market that warns the driver when it detects that the vehicle starts to swerve out of its safety route position on the road. There are no precedents in even international markets that have been government approved.

There have been some inventions to increase the awareness of the driver as a safety feature, but no invention has yet succeeded to work efficiently and practically. Most precedent equipment detects the problem after it has occurred which makes it fail to warn the driver on time. To illustrate this point, let's look in more detail of equipment that works in this way. There is equipment that is placed either at the ears or parts of the human body to detect when the person starts to fall asleep. This equipment fails to work efficiently because of several characteristics. It is first of all not practical because it is not convenient and comfortable for the user which could disrupt the user's driving. Secondly, it fails to warn the user on time because it has been proven that a person falls asleep first before they show signs of actual falling asleep.

The equipment that detects eye pupil aperture of the driver have been found to be even less efficient and impractical than the first method, has more false alarms, and are extremely high in cost.

gnal.

America's patented equipment U.S. Pat. No. 4,564,833 utilizes a system that measures the angle of movement of the steering wheel by inputting an angle that it should not exceed in normal driving behavior to engage the warning signal. If the steering wheel movement doesn't meet the inputting angle requirement, the warning signal will not engage because that movement behavior doesn't consider the driver to be falling asleep.

America's patented equipment U.S. Pat. No. 4,604,611 utilizes a system that measures the angle of the position of the steering wheel that exceeds the inputted unsafe angle of the position of the steering wheel as well. The difference is it considers the driver to be unfit to drive by utilizing a system that measures the amount of times the steering wheel movement exceeds the inputted safe amount of times.

Both patented equipment fail to work even though the equipment is similar to our invention by both monitoring the movement of the steering wheel. In roads with very smooth terrain, the movement of the steering wheel moves at very short and acute angles; the movement can be affected by multiple factors such as type of vehicle, terrain of the road, each individual driver, and the temperament of the driver at certain periods of time. Therefore, by monitoring the multitude of times at a constant rate often fail to work well including the false alarms it generates and difficulty of disengaging the false alarms when they occur. These false alarms can work inversely against the driver by possibly causing accidents.

### SUMMARY OF INVENTION

The purpose of this invention is to fix problems of the previous design. Using the theory stated as, While an alert driver is operating any kind of vehicles that used steering wheel to control directions, the steering wheel would always never standstill (almost always moving). By stop adjusting movement of the steering wheel for too long, while gas pedal is pressed, shows that the driver is loosing necessary attention of driving, such driver could be looking at the walkway, changing radio station, daydreaming, or falling asleep.

By detecting the movement period of turning steering wheel, while a driver is still alert (at the beginning of accelerating the vehicle). Automatic Driver's Aide will record the first moment of the movement time of steering wheel in its memory, once the longest movement time of steering wheel has been recorded, it will then use this data as a base of comparison to the movements and adjustments in the next stage. If the amount of compared movement time is greater than the amount of the previous recorded time, it can be proved that the driver is not paying enough attention while operating vehicle. If the steering movement time as stated above is too long, it may cause unsafe driving. The Automatic Driver's Aide device will take control of steering wheel before the vehicle go out of its lane, by detecting and centralizing the position of vehicle from line on the road and/or send warning alarm to the driver.

### BRIEF DESCRIPTION OF DRAWINGS

FIG. 1 Block diagram of the Automatic Driver's Aide according to this invention

FIG. 2 Timing diagram of the processing unit.

### DETAILED DESCRIPTION

Concerning Technical

Engineering, Electronics, Alarm, and Logic

Description

heel is stagnant at a certain straightforward position.

It can be concluded that when the movement of the steering wheel is stagnant longer than usual driving behavior, the driver is losing the necessary attention needed to operate the vehicle safely (for what any reason). Our assist safety equipment will start to function at this point to prevent the car from running out of its course while at the same time send an alarm signal. To prevent false alarms, we will have to take the following actions:

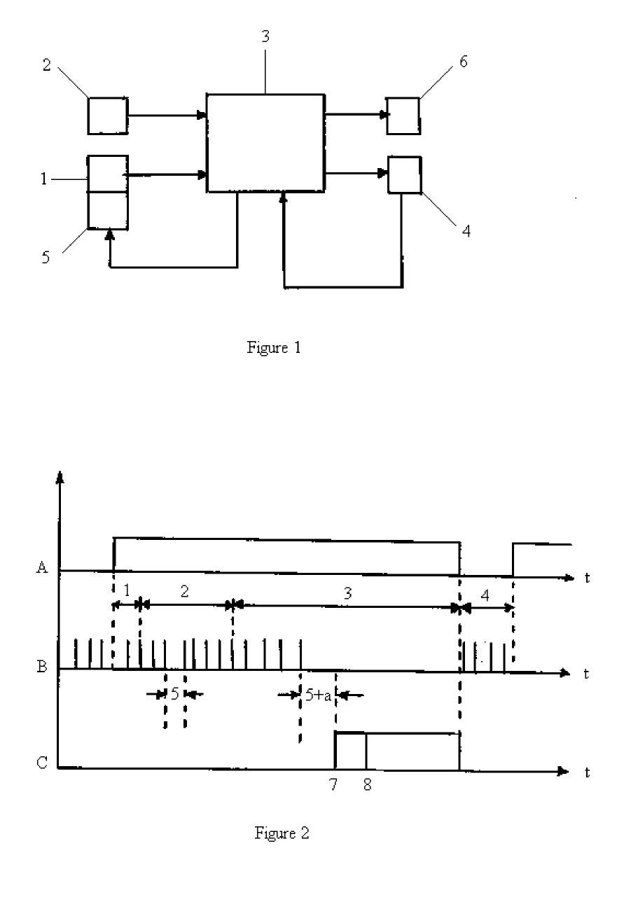

FIG. 1

The detector that monitors the deviating movements on the steering wheel 1 will be installed onto the steering column of the vehicle. Every time the steering wheel moves in reverse direction, a single pulse signal will be generated. Each time frame between each interval of steering wheel movement in reverse direction will be monitored and recorded; this signal will be called steering wheel movement signal.

The detector that monitors the movement of the gas pedal 2. This detector will generate RESET signal if the engine runs slower RPM than a set value and will generate a reset pulse at every time the engine increases the RPM; this signal will be known as the gas pedal signal.

Both mentioned signals include steering wheel movement signal 1 and gas pedal signal 2 will be sent to the Processing Unit 3 to process and calculate the two signals.

The processing unit 3 might be just a simple digital electronic device, or a microprocessor. Processing unit 3 will receive both signals described above and will respond to the signals as programmed or designed circuit for that application. It will then respond when it predicts that the driver of the vehicle is losing consciousness. When it discovers that the driver is starting to lose consciousness or lack of attention in controlling the vehicle, then the processing unit 3 will send a signal to the driving assist device mechanism for assisting the driver.

The driving assist device mechanism consists of:
a) Line Tracker 4, which monitors the distance of the car from the separate lane line on the road
b) The steering wheel actuator 5—a device that controls the steering wheel. The processing unit 3 will then also send another signal to the Alarm 6, which engages the warning signal

The processing unit 3 program does two primary jobs:
1) Detecting the inattention stage of the driver—it monitors the status of the driver controlling the vehicle
2) Controlling the driving assist device mechanism, also known as Driver's Assisting Device

Detecting the Inattention Stage of the Driver

FIG. 2

This illustrates the timing diagram of the processing unit 3 of FIG. 1, which are consists of:
a) The signals from the gas pedal 1 of FIG. 1A
b) The signals from the steering wheel B
c) The output signal of the processing unit 3 of FIG. 1C
The driver's assisting device signal 7
The alarm signal 8

When a signal is sent from the gas pedal A (accelerating) the processing unit 3 in FIG. 1 will change the status from Reset to Active by counting the amount of signals B received from the steering wheel movement detector 1 in FIG. 1. It will also keep track of the time intervals between each signal. The results gathered here will lead to further processes that are divided up into 4 stages as follows:

Stage 1: Beginning Stage

This stage starts from the processing unit 3 of FIG. 1 receiving signals from the gas pedal A and starts to count the number of the steering wheel movement signal B that are not yet numerous (shouldn't exceed 5 rounds). In the beginning we might set the time lapse longer than usual without having signals coming from the steering wheel. The reasoning behind this is that it is impossible for the driver to be unconscious after the acceleration of the gas pedal without adjusting any steering wheel movements. You could adjust the monitoring to 2-3 rounds (but shouldn't exceed 5 rounds) and during this period, collective data during this period shouldn't be used as a basis for further programming.

Stage 2: Learning Stage

After Stage 1 we will call the next stage the Learning, Stage 2. This stage will focus on analyzing the driver's behavior. It will learn the normal driving behavior of the driver such as how often does the driver moves and adjusts the steering wheel by recording the longest period of time the steering wheel moves and adjusts back and forth. It will then use this data as a base of comparison to the movements and adjustments in the next stage when the driver's unconscious is detected.

The purpose of Learning Stage 2, is to find the actual time of the longest round, meaning the longest actual time within the group that is close in values to others in that group. This is because the actual time that is much longer than the norm (might be caused from encountering a hold, accelerating pass other vehicles, or sudden shifts in movement to avoid certain obstacles on the road. This value will be automatically deleted to prevent the equipment from detecting periods of consciousness slower than required to be efficient. In the Learning Stage 2, the longest actual time of the recorded data will be used as the base time to monitor and detect periods of consciousness later on.

Stage 3: Detection Stage

The next stage after Learning Stage 2 will be known as Detecting Stage 3. In this stage, the highest actual time recorded 5 from the Learning Stage 2 will be added with a fixed value (a) that is used to describe the level of alertness of the driver. If the value a is small, this means that the driver needs to be driving with more alertness. The sum of these two values (5+a) will be used as a base time in the detecting stage 3. Any excess time than this summed values (5+a), the processing unit 3 of FIG. 1 will react by sending the driver's assist signals 7 to operate the assisting devices consist of line tracker 4 of FIG. 1, the steering wheel actuator 5 of FIG. 1, and the alarm signal 8 for warning in consecutive order.

While the warning signal 8 is activated, or during the driver's assist signal 7 is activated; if there are any signals from the driver, which are consists of signals from the steering wheel B, or signals from the gas pedal A was received, then the processing unit 3 of FIG. 1 will go into Reset Stage 4. During reset stage 4, all previously recorded statistics from the Learning Stage 2 will be erased and the equipment will stop functioning as a whole, ready to restart the whole process from the beginning all over again.

Stage 4: Reset Stage

The reset stage 4 will be occurred if the engine runs slower than a set point or if the engine just increased its RPM.

Controlling the Driver's Assisting Device

3 of FIG. 1 discovers that the vehicle is not in the correct position, a warning signal will be activated and/or a signal will be sent to the steering wheel actuator 5 in FIG. 1, to assist the driver in controlling the steering wheel. This steering wheel actuator has similar characteristics as a clutch; this will allow the driver to have priority on the controls of the steering wheel.

Method of Perfect Invention

As mentioned above, in the detail of invention.

1. The Automatic Driver's Aide according to this invention consists of the processing unit that will function as programmed and/or designed in the circuit, only when the gas pedal detector detected that the engine is running faster than the set point. It will monitor and/or record the interval movement of the steering wheel, which received from the steering wheel movement detector. To analyze this signal as designed or programmed for this purpose. The Automatic Driver's Aide in this invention will come to assist the driver in driving and/or set off the alarm if there is no incoming steering wheel movement signal from the steering wheel movement detector for longer period of time than a certain fix time plus a maximum period of time of the steering wheel movement that recorded, which was proved in this invention that the driver is lacking of sufficient attention than required to operate the vehicle safely.

2. The Automatic Driver's Aide according to claim 1 where the mentioned programmed and/or the designed circuit will be functioned from the input it received by divided up into 4 segments, which include the beginning stage, learning stage, detecting stage, and the resetting stage.

3. The Automatic Driver's Aide according to claim 1 and claim 2, where the mentioned beginning stage is the time frame from the beginning when the engine is running faster than a set point or the engine is just increased in RPM. Within this period, the number of movement of steering wheel is in small amount, there will be no gathering of data from steering wheel, there will be no warning signal activated, or driver assist activated.

4. The Automatic Driver's Aide according to claim 1, claim 2, and claim 3, where the said learning period is the period follows the beginning period. This is the period that the processing program or circuit will monitoring and finding the longest movement period of the steering wheel for the purpose of recording it as a statistic data to compare with the following movement of the steering wheel after the Learning Stage. There is an exception to this movement data, the value must be closed to one another. If the movement period data is much longer than usual, it will be rejected.

5. The Automatic Driver's Aide according the claim 1, claim 2, and claim 4, where the mentioned detecting stage is the period of monitoring, looking for lack of control. The processing unit will compare time frame of the steering wheel movement with the longest time frame as mentioned in claim 4. If the time frame is longer than the longest period mentioned in the claim 4 plus the fixed value, that the processing unit will activate the warning signal and/or the driver assist equipment.

6. The Automatic Driver's Aide according to claim 1 and claim 5, where the mentioned driver assist equipment consists of equipment that monitors the dividing lane line on the road. It sends the vehicle position data signal to the processing unit to be analyzed if the vehicle is in a position, as it should be or not. It will send a control signal to the steering wheel actuator for adjusting the position, until the vehicle is in the right position

7. The Automatic Driver's Aide according to claim 1 and claim 6, where the mentioned steering wheel actuator has clutch characteristics. It is able to rotate the steering wheel in either direction as commanded by the processing unit, and at the same time, the driver still remains in control of the steering wheel as desired.

8. The Automatic Driver's Aide according to claim 1 and claim 2, where the mentioned resetting stage is the stage during the engine runs slower RPM than a set point or as a reset pulse when the engine increased in its RPM. At this stage, all activities such as alarm and driver assist equipment will be stopped; the recorded learning data will be deleted and ready to repeat the whole process again.
